(19) United States
(12) Patent Application Publication
(10) Pub. No.: US 2005/0247143 A1
(43) Pub. Date: Nov. 10, 2005

(54) Packaging machine with a displacement unit

(76) Inventor: Ernst-Walter Schmitt, Dautphetal (DE)

Correspondence Address: PERMAN & GREEN, 425 POST ROAD, FAIRFIELD, CT, 06824, US

(21) Appl. No.: 10/526,723

(22) PCT Filed: Aug. 28, 2003
(86) PCT No.: PCT/EP03/09531

§ 371 Date: Mar. 4, 2005

(30) Foreign Application Priority Data
Sep. 6, 2002 (DE) 10241802.0

(51) Int. Cl. F16H 21/16

(52) U.S. Cl. 74/25

(57) ABSTRACT

A packaging machine with a displacement unit with a running packaging item support arranged on the displacement unit.

The present invention relates to a packaging machine with a displacement unit, wherein a co-travelling packaging item support means is arranged on the displacement unit.

Package contents, for example foodstuffs, are these days ever more frequently offered for purchase to the consumer in plastics packs. These plastics packs generally comprise a packaging tray, in which the package contents are located, and a lidding film. The lidding film is sealed to the packaging tray.

Such packs are often produced using packaging machines, so-called thermoformers, in which a plurality of packaging trays may be thermoformed from a so-called base film. After thermoforming, the respective packaging tray is filled with package contents and then sealed with a lidding film. As a last step, the finished packs are separated from one another using a longitudinal and transverse cutter or by a compound die.

Such packaging machines have these days to be ever more flexibly and quickly adjustable to the pack type or pack size desired by the customer. For this reason, a corresponding number of cutting devices have to be kept ready on the machine.

The object of the present invention is therefore to provide a packaging machine which fulfils the above-mentioned requirements.

This object is achieved according to the invention by a packaging machine with a displacement unit on which there is arranged a co-travelling packaging item support means.

For the purposes of the invention, a packaging machine is any desired thermoforming packaging machine familiar to the person skilled in the art, in which a plurality of packaging trays are thermoformed from a so-called base film, which packaging trays are filled after thermoforming with package contents, for example foodstuffs, and then sealed with a lidding film and finally cut apart from one another.

According to the invention, this packaging machine comprises a displacement unit. For the purposes of the invention, a displacement unit is for example a punching machine, a sealing station and/or a transverse cutter, which is displaceable along the machine in or contrary to the conveying direction of the film(s) at least over a certain range. The displacement unit may, however, be arranged in any desired portion of the packaging machine downstream of the thermoforming station relative to the conveying direction of the film.

The displacement unit is preferably displaced by a motor in or contrary to the direction of product flow.

Also according to the invention, at least one co-travelling packaging item support means is arranged on the displacement unit. This packaging item support means is preferably a cable, particularly preferably a wire cable. Also preferred as the packaging item support means is a thin resilient belt of any desired width. The cable and/or belt extends under the base film and parallel to the direction of displacement of the displacement unit and is arranged between two packs, such that the base film, which is formed into the packs, does not sag.

Preferably, each cable or belt comprises a first and a second end, which are each arranged removably on the displacement unit.

Preferably, a plurality of cables or belts are arranged one after the other perpendicularly to the running direction of the base film. It is also preferable for the packaging machine according to the invention to comprise at least four rollers, with which the cable and/or the belt is deflected. These rollers are preferably arranged on the frame of the packaging machine by means of plug-in strips. The embodiment with plug-in strips has the advantage that the packaging machine according to the invention may be simply and rapidly converted for another pack shape or size. The position of the rollers may be adapted to the corresponding requirements.

In a further preferred embodiment of the present invention, the cable and/or the belt may be tensioned with a means. This means is preferably arranged on the displacement unit. By tensioning of the cables and/or belts, it is possible to take account of the respective loads on the cables and/or belts, such that the film, which they support, does not sag. The cable or belt should not be too strongly tensioned, however. Preferably, a tensioning means is assigned to each cable or belt. Particularly preferably, the displacement unit likewise comprises at least one plug-in strip, to which the cables and/or belts are in each case individually attached and then individually tensioned.

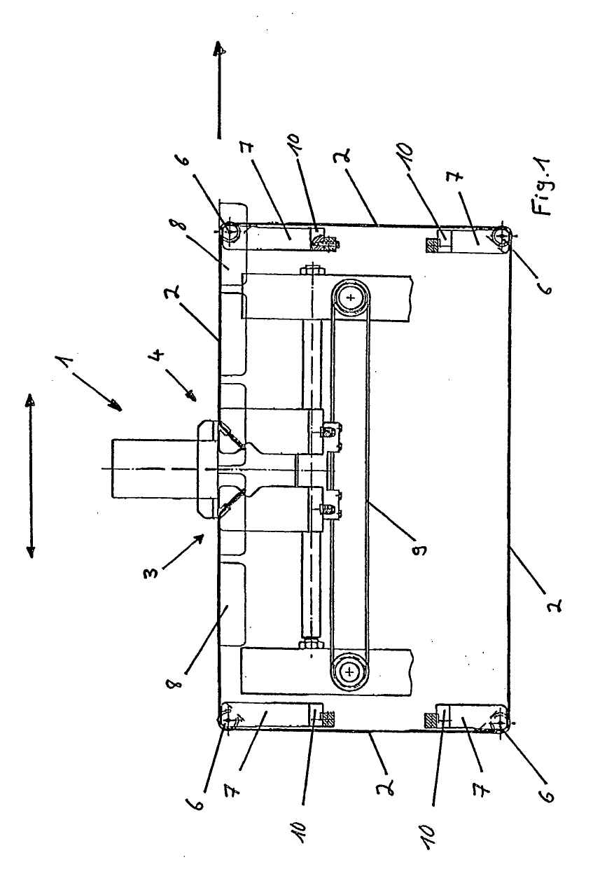

The invention is explained below with reference to FIGS. 1-4. These explanations are only given by way of example and do not restrict the general concept of the invention.

FIG. 1 shows a side view of the displacement unit of the packaging machine according to the invention,

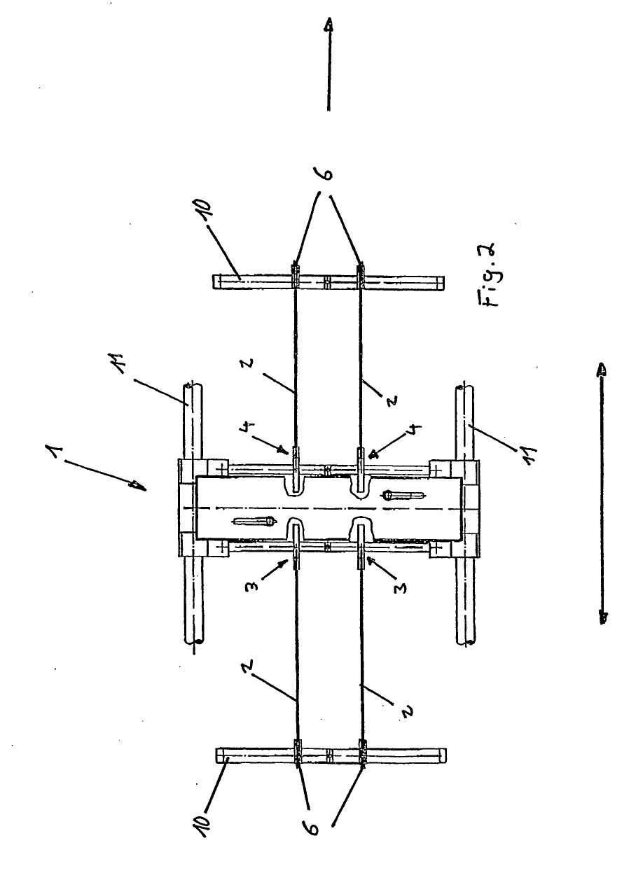

FIG. 2 shows a plan view of the displacement unit according to FIG. 1,

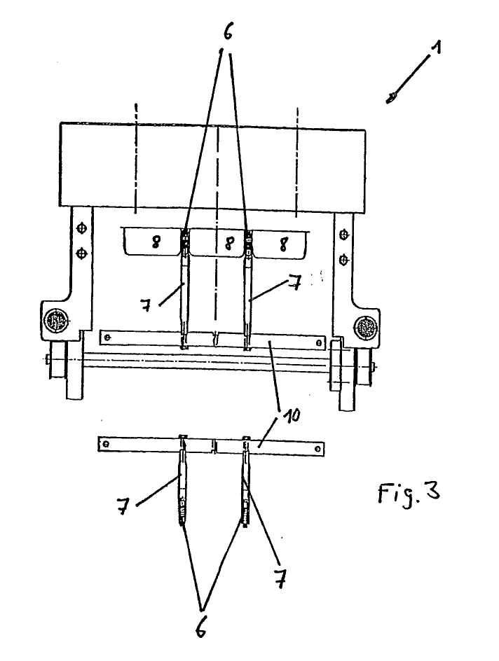

FIG. 3 shows a front view of the displacement unit according to FIG. 1 and

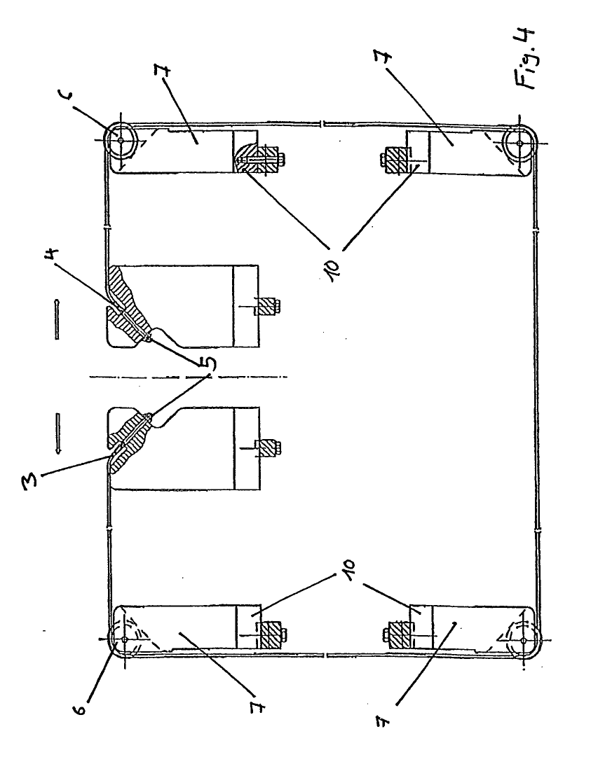

FIG. 4 shows a partial section through the displacement unit according to FIG. 1.

FIG. 1 shows part of the displacement unit 1. The displacement unit 1 is part of a packaging machine, which comprises a thermoforming, a filling, a sealing and a cutting station. The displacement unit may assume one of the last three functions. On the displacement unit 1, in the present case a transverse cutting station, there is arranged a packaging item support means 2, a wire cable 2. The cable 2 is deflected by means of the four rollers 6 and is connected detachably with its ends 3, 4 to the displacement unit 1. The packaging trays 8, which move in the direction represented by the arrow, are supported in such a way by the cable 2 that the film from which the respective packaging trays are formed does not sag either lengthwise or crosswise relative to the running direction thereof. The person skilled in the art will recognise that a plurality of packaging trays 8 may be arranged one behind the other in the paper plane and accordingly a plurality of packaging item support means 2 are also arranged one behind the other. The rollers 6 are mounted on plug-in strips 7, which are positioned flexibly on the transverse strips 10 and screwed thereon. By using plug-in strips 7 it is possible for the packaging machine according to the invention to be adjusted flexibly to the particular pack shape or size. The displacement unit 1 is driven by means of the toothed belt 9 and a motor, not shown, and may be displaced in the direction represented by the double-headed arrow. Conventional packaging item support means are located up- and downstream of the displacement unit relative to the running direction of the film. The length of the cables 2 may be adapted to the length of the displacement unit.

FIG. 2 shows a plan view of the displacement unit according to FIG. 1, in which the upper part of the transverse cutting station and the packaging film with the packaging trays 8 are not shown. It is clear from this view that two packaging item support means 2 are arranged one behind the other transversely of the running direction of the machine, which is represented by the arrow. Each cable 2 is provided with a means 5 (not shown in this view) with which the tension of the respective cable may be individually adjusted. The individual adjustment of the tension of the respective cable has the advantage that the tension of the cable may be adapted to particular local requirements. The tension of the cables in the middle of the packaging machine will be higher than the tension of the cables in the marginal area of the packaging machine. In the present case, the tension of the two cables is the same. Furthermore, it is clear from this view that the displacement unit 1 is displaceable on the rods 11 along the double-headed arrow in the running direction of the machine.

FIG. 3 is a front view of the displacement unit according to FIG. 1. It is clearly visible from this view how the cables 2 and the rollers 6 support the packaging trays 8 in such a way that they do not sag either lengthwise or crosswise relative to the running direction of the machine.

FIG. 4 shows a section through the displacement unit according to FIG. 1. It is clear from this view that the ends 3 and 4 of the cable 2 are arranged detachably on the displacement unit 1 and may be tensioned by means of the screws 5. The person skilled in the art will recognise that at least one tensioning means 5 and four rollers 6 with the associated plug-in strips 7 are assigned to each cable 2. The person skilled in the art will furthermore recognise that one screw is sufficient for tensioning the cables. The present embodiment has the advantage, however, that the connection between cable 2 and displacement unit 1 may be more quickly made and detached again.

1. A packaging machine having a displacement unit, characterised in that a co-travelling packaging item support means is arranged on the displacement unit.

2. A packaging machine according to claim 1, characterised in that the packaging item support means is at least one cable.

3. A packaging machine according to claim 2, characterised in that each cable comprises a first and a second end, which are each arranged on the displacement unit.

4. A packaging machine according to claim 3, characterised in that it comprises rollers, with which the cable is deflected.

5. A packaging machine according to claim 4, characterised in that the rollers are arranged by means of plug-in strips on the frame of the packaging machine.

6. A packaging machine according to claim 3, characterised in that the displacement unit comprises at least one means with which the cable may be tensioned.

7. A packaging machine according to claim 6, characterised in that a means is assigned to each cable

8. A packaging machine according to claim 1, characterised in that the displacement unit is driven by a motor or a pneumatic cylinder.

9. A packaging machine according to claim 1, characterised in that it is a thermoforming packaging machine.

10. A packaging machine according to claim 1, characterised in that the displacement unit is a cutting means, a sealing means, a forming means or a filling means.
